(19) United States
(12) Patent Application Publication
(10) Pub. No.: US 2015/0222214 A1
(43) Pub. Date: Aug. 6, 2015

(54) SYSTEM FOR CONTROLLING THE ELECTROMAGNETIC TORQUE OF AN ELECTRIC MACHINE IN PARTICULAR FOR MOTOR VEHICLE

(71) Applicant: RENAULT s.a.s., Boulogne-Billancourt (FR)

(72) Inventors: Abdelmalek Maloum, Chevilly La Rue (FR); Ludovic Merienne, Gif Sur Yvette (FR)

(73) Assignee: RENAULT s.a.s, Boulogne-Billancourt (FR)

(21) Appl. No.: 14/420,093

(22) PCT Filed: Jul. 25, 2013
(86) PCT No.: PCT/FR2013/051788

§ 371 Date: Feb. 6, 2015

(30) Foreign Application Priority Data
Aug. 6, 2012 (FR) 1257616

(51) Int. Cl. H02P 21/00

(52) U.S. Cl. CPC H02P 21/0035

(57) ABSTRACT

A system for controlling electromagnetic torque of an electric machine, for example for a motor vehicle. The system can control electromagnetic torque of a permanent-magnet three-phase electric machine and includes a mechanism measuring a current, a transposition mechanism configured to transpose three measured currents into a direct component and a quadratic component of current on the basis of a transform of three-phase systems, a transformation mechanism configured to convert a torque setpoint into a setpoint for the quadratic component of current and a setpoint for the direct component of current, a mechanism for determining control voltages, and a controller configured to apply the control voltages determined to the electric machine.

The invention relates to a method for controlling an electromagnetic torque of a transmission of a motor vehicle equipped with an electric drive machine, and in particular of a hybrid transmission of a motor vehicle equipped with a heat engine and an electric drive machine.

A hybrid transmission generally comprises two concentric primary shafts, each carrying at least one step-down gear on a secondary shaft connected to the wheels of the vehicle, and a first coupling means between the two primary shafts that can occupy three positions: a first in which the heat engine is decoupled from the kinematic chain connecting the electric machine to the wheels, a second in which the heat engine drives the wheels independently of the electric machine, and a third in which the heat engine and the electric machine are coupled such that the respective torques thereof are added in the direction of the wheels.

There are also three positions in order to connect the primary shaft, connected to the electric motor, to the secondary shaft: a first in which the electric motor is not directly coupled to the secondary shaft, a second in which the electric motor is directly connected to the secondary shaft with a first ratio, and a third in which the electric motor is directly connected to the secondary shaft with a second ratio.

In the case in which only the electric machine provides the traction torque to the motor vehicle, that is to say in a case of purely electric traction as in a motor vehicle having purely electric traction, the torque provided by the electric machine must be controlled. Since the torque of an electric machine is directly linked to the currents circulating therein, these currents must be controlled in a precise manner.

In an electric machine, in particular a permanent-magnet axial-flux three-phase synchronous machine, the currents in the three phases of the stator are sinusoidal and are phase-shifted in each case by

$$\frac{2 π}{3} rad .$$

These currents create a rotating magnetic field in the electric machine. The rotor is composed of permanent magnets, for example between 1 and 5 pole pairs. Similarly to a compass, the rotor aligns itself naturally with the rotating magnetic field created by the rotor. Thus, the frequency of rotation of the rotor is equal to the frequency of the currents of the stator (synchronous). It is the amplitudes of the currents of the stator and the power of the magnets of the rotor that create the torque necessary for rotation of the machine. In order to control these currents, it is thus necessary to apply sinusoidal voltages each also phase-shifted by

$$\frac{2 π}{3} rad$$

to each phase of the stator.

Generally, it is easier to apply a regulation to constants than to sinusoidal signals. A transform of three-phase systems, such as Park's transform, is generally used to project a three-phase system in a two-dimensional space in order to produce an equivalent mono-phase system. It is thus possible to transpose the three currents and the three sinusoidal voltages of the stator relative to the three phases of a three-phase system in a space in which the three sinusoidal signals of current or of voltage are expressed in the form of two constant signals of current or of voltage, one on the direct axis X_{d} and the other on the quadrature axis X_{q}. For this, Park's reference frame is based on a reference frame linked to the rotating field, that is to say in the case of the synchronous machine on a reference frame linked to the rotor.

By working with currents and voltages expressed in Park's space, it is thus possible to influence constant currents or voltages rather than sinusoidal signals in order to regulate the three-phase machine to be controlled.

By performing the inverse transform, it is possible to return to the normal reference frame of the machine and therefore to know exactly which voltages or which currents to apply at each phase of the machine.

The use of a battery as a power supply for the three-phase electric machine imposes additional constraints in that the applicable voltages are limited by the capacitances of the battery. In fact, it is not possible to reach certain setpoints due to these limitations. A setpoint outside the attainable scope is often a generator of instability.

One object of the invention is to ensure the stability of the currents in the machine during regulation thereof in spite of the voltage limitations. If, with these constraints, the setpoints remain unattainable, then the object is to reach as close as possible to the setpoint.

Document U.S. Pat. No. 6,181,091 describes a method for controlling a permanent-magnet synchronous machine in which saturation is avoided by modifying the functioning of the pulse-width modulation (PWM) module ensuring the voltages across each branch of the motor. In this known control method, the electromagnetic torque accessible by the synchronous machine is reduced in order to avoid voltage saturation, in particular by directly controlling a component of current in Park's space.

In general, in order to control the quadratic component of current, a mapping giving the direct component of the current as a function of the quadratic component setpoint to be reached is used. This method has the disadvantage of having to perform a series of adjustments on the current mappings. In addition, there is no way of ensuring that currents optimal for a given electromagnetic torque will be obtained. In fact, with this mapping method, in order to ensure that conditions of voltage saturation are not encountered, a safety margin with regard to the value of the direct component of current is provided, that is to say the direct component of current is decreased more than is necessary so as not to risk encountering saturations when controlling the system. This safety margin is implemented to the detriment of the output of the machine.

Such a reduction of the direct component of the current involves a reduction of the voltages and therefore a decrease of the accessible electromagnetic torque.

The invention proposes providing a method for controlling the electromagnetic torque of a permanent-magnet electric machine making it possible to ensure the stability of the currents in the electric machine, whatever the state of the electric machine and with constant predetermined gains of the regulator.

In accordance with one aspect of the invention, it is proposed in one embodiment to provide a system for controlling the electromagnetic torque of a permanent-magnet three-phase electric machine, comprising means for measuring the current delivered across the three phases of the machine, transposition means able to transpose the three currents measured into a direct component and a quadratic component of current on the basis of a transform of three-phase systems, transformation means able to convert a torque setpoint into a setpoint for the quadratic component of current and a setpoint for the direct component of current, means for determining the control voltages, and control means able to apply the determined control voltages to the electric machine.

In accordance with a general feature of the invention, the determination means comprise a first calculation module receiving said direct and quadratic components of current and also said setpoints, the first calculation module being able to apply a change of variables and to provide a set of control variables to a regulation module able to deliver control parameters calculated on the basis of a system of equations as a function of the control variables, the system of equations isolating the disturbance terms caused by the flux generated by the magnets of the rotor of the electric machine from the terms contributing to the electromagnetic torque, and a second calculation module able to calculate the control voltages on the basis of the direct and quadratic components of voltage determined on the basis of the control parameters.

The change of variable makes it possible to transform the system of equation regulating the electromagnetic torque expressed in Park's space into a system of equations comprising endogenous variables specific to the electromagnetic torque and exogenous variables specific to the disturbances caused by the flux. This change in variable thus makes it possible to isolate the frequency of the disturbances from the control of the electromagnetic torque and thus to offset the disturbances.

This control system also makes it possible to decrease the current ripples of the electric machine and thus to smooth the electromagnetic torque of the electric machine.

The transform of three-phase systems can be a Park's transform. It can also be a Fortescue transform, a Clarke transform or a Ku transform.

In Park's space the variables comprise a direct component and a quadratic component applied to the two axes of Park's plan (direct axis and quadrature axis) of the synchronous machine. The direct and quadratic components of voltage are expressed as a function of the direct component and quadratic component of the current of the synchronous machine.

Advantageously, the synchronous machine has a symmetry between the direct axis and the quadrature axis of the plan of the transform of three-phase systems, making it possible to obtain a direct component of equivalent inductance substantially equivalent to the quadratic component of equivalent inductance.

This symmetry can be obtained during the manufacture of the electric machine by using smooth non-salient poles. It makes it possible to express the electromagnetic torque of the electric machine as a function of a unique factor of flux caused by the magnets of the electric machine.

In Park's space the system of equations to be regulated is expressed on the basis of control variables in accordance with the following expression:

$$\{ \begin{matrix}{U}_{d} = {R}_{s} {X}_{d} + \frac{{L}_{s}}{3} {\dot{X}}_{d} + {P}_{d} ( t ) \\ {U}_{q} = {R}_{s} {X}_{q} + {L}_{q} {\dot{X}}_{q} + {P}_{q} ( t )\end{matrix}$$

With Lₛ=L_{d}=L_{q} an equivalent inductance, and Rₛ=R_{d}=R_{q} an equivalent resistance, X_{d}=I_{q}³+I_{d}³ and X_{q}=I_{q}−I_{d}, I_{d} representing the direct component of the current delivered by the electric machine and I_{q} the quadratic component thereof, and U_{d}=I_{d}²V_{d}+I_{q}²V_{q} and U_{q}=−V_{d}+V_{q}, V_{d} representing the direct component of the voltage at the terminals of the electric machine and V_{q} the quadratic component thereof.

P_{d}(t)=−ωᵣI_{q}└LₛI_{d}(I_{q}−I_{d})+φ_{f}┘ and P_{q}(t)=ωᵣ└Lₛ(I_{d}+I_{q})+φ_{f}┘ corresponding respectively to the direct component and to the quadratic component of the disturbances expressed in Park's space, Φ_{f} representing the flux generated by the magnets of the machine, and ωᵣ representing the speed of rotation of the magnetic field of the machine.

The control parameters, on the basis of which the quadratic and direct components of voltage and then the control voltages are determined, are calculated on the basis of the following expression:

$$\{ \begin{matrix}{U}_{d} = {K}_{d} ( {X}_{d}^{req} - {X}_{d} ) + {K}_{id} \int ( {X}_{d}^{req} - {X}_{d} ) d t \\ {U}_{q} = {K}_{q} ( {X}_{q}^{req} - {X}_{q} ) + {K}_{iq} \int ( {X}_{q}^{req} - {X}_{q} ) d t\end{matrix}$$

With K_{d}, K_{id}, K_{q}, K_{iq} representing the predetermined constant gains, and X_{d}^{req}=(I_{q}^{req})³+(I_{d}^{req})³ and X_{q}^{req}=I_{q}^{req}−I_{d}^{req}, I_{d}^{req} representing the setpoint of current of the direct component and I_{q}^{req} representing the setpoint of current of the quadratic component.

In accordance with a further aspect of the invention, it is proposed in accordance with one mode of implementation to provide a method for controlling the electromagnetic torque of a permanent-magnet three-phase electric machine comprising, the measurement of the current delivered across the three phases of the electric machine, a transposition of the three currents measured into a direct component and a quadratic component of current on the basis of a transform of three-phase systems, the receipt of two setpoints for the quadratic component and the direct component of current in the plan associated with the transform of three-phase systems, a determination of the control voltages and a control of the voltages to be applied to the electric machine, characterized in that the determination of the control voltages comprises a change of variable providing the control variables, a regulation of the control parameters calculated on the basis of a system of equations expressed as a function of the control variables, the system of equations isolating the disturbance terms caused by the flux generated by the magnets of the rotor of the electric machine from the terms contributing to the electromagnetic torque, and a calculation of the control voltages on the basis of the direct and quadratic components of voltage determined on the basis of the control parameters.

Further advantages and features of the invention will become clearer upon examination of the detailed description of a non-limiting mode of implementation and of a non-limiting embodiment and also upon examination of the accompanying drawings, in which:

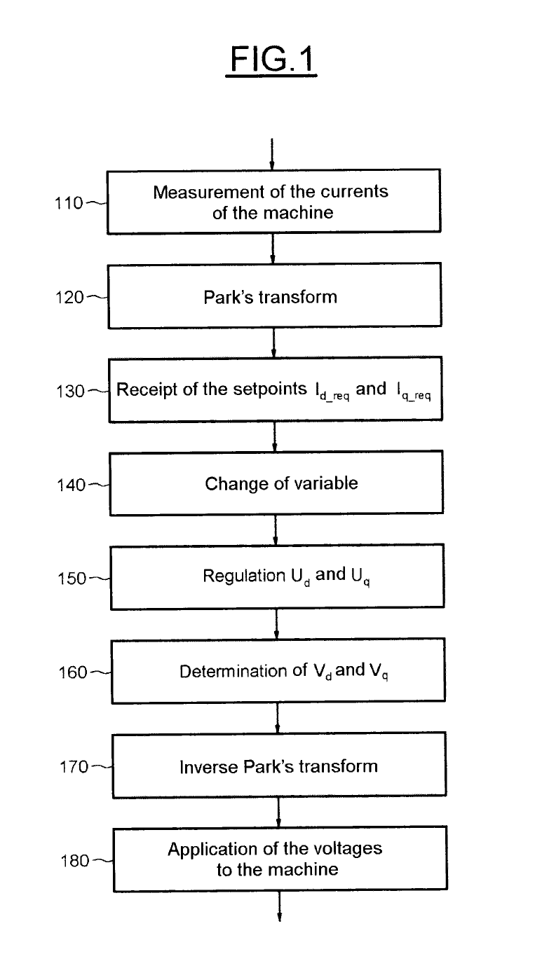

FIG. 1 shows a flow chart of a method for controlling the electromagnetic torque of a permanent-magnet three-phase electric machine in accordance with one mode of implementation;

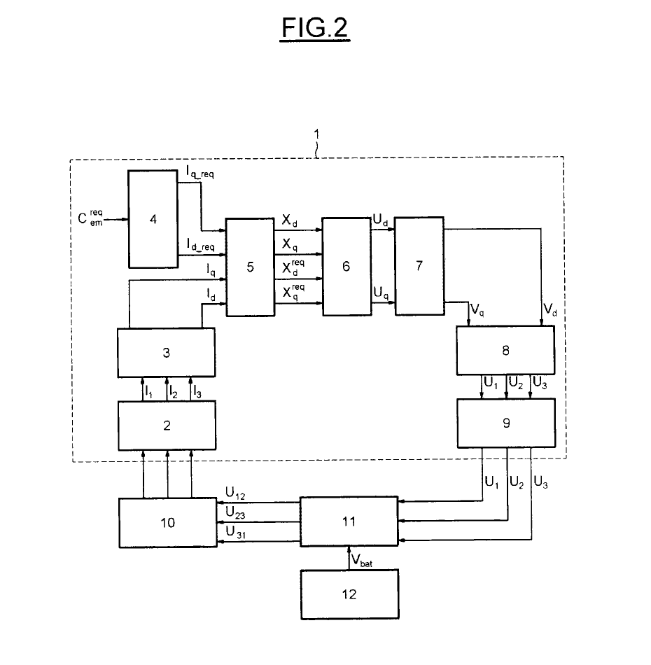

FIG. 2 schematically illustrates a system for controlling the electromagnetic torque of a permanent-magnet three-phase electric machine in accordance with an embodiment of the invention.

FIG. 1 shows a flow chart, in accordance with one mode of implementation of the invention, of a method for controlling the electromagnetic torque of a permanent-magnet three-phase synchronous machine.

In a first step 110, the current I₁, I₂, I₃ is measured for each of the three phases of the permanent-magnet three-phase synchronous machine.

In a second step 120, Park's transform is applied to the three currents measured I₁, I₂, I₃ so as to express the current delivered by the electric machine in a reference frame rotating in accordance with a direct component I_{d} of current and a quadratic component I_{q} of current.

In Park's space, the system of equations to be controlled for the synchronous machine is as follows:

$$\{ \begin{matrix}{V}_{d} = {R}_{s} {I}_{d} + {L}_{d} {\dot{I}}_{d} - {ω}_{r} {L}_{q} {I}_{q} \\ {V}_{q} = {R}_{s} {I}_{q} + {L}_{q} {\dot{I}}_{q} - {ω}_{r} ( {L}_{d} {I}_{d} + {φ}_{f} )\end{matrix} \qquad ( 1 )$$

With V_{d} and V_{q} the voltages applied across the two axes (direct axis and quadrature axis respectively) of the Park plan of the electric machine, I_{d} and I_{q} the currents circulating in the machine across the two axes (direct axis and quadrature axis respectively) of the Park plan, Rₛ the equivalent resistance of the stator of the machine, L_{d} and L_{q} the equivalent inductances across each axis (the direct axis and quadrature axis respectively) of the Park plan of the machine, ωᵣ the speed of rotation of the magnetic field of the machine, which amounts to the speed of rotation of the rotor multiplied by the number of pairs of poles of the machine, and Φ_{f} the flux generated by the magnets of the rotor.

The electromagnetic torque generated by the synchronous machine can be calculated on the basis of the following expression:

Cₑₘ=p(φ_{d}I_{q}−φ_{q}I_{d}) (2)

With Cₑₘ the electromagnetic torque generated by the machine, p the number of pairs of poles of the rotor of the machine, and φ_{d} and φ_{q} the components of the flux generated across the axes (direct axis and quadrature axis respectively) of the machine, expressed in the following form:

φ_{d}=L_{d}I_{d}+φ_{f} and φ_{q}=L_{q}I_{q} (3)

In the present case, the synchronous machine has a symmetry between the direct axis and the quadrature axis of the Park space making it possible to obtain the remarkable property L_{d}=L_{q} and thus to write

Cₑₘ=pφ_{f}I_{q} (4)

In such a machine, in order to control the torque by maximally limiting the Joules loses generated by the direct component I_{d} of the current, it is necessary to make provisions so as to have a direct component I_{d} of the current as close to zero as possible, because only the quadratic component I_{q} contributes to the electromagnetic torque.

In a step 130, a first setpoint I_{q}_{_{—}}_{req} for the quadratic component I_{q} of current and a second setpoint I_{d}_{_{—}}_{req} for the direct component I_{d} of current are received in the plan associated with the transform of three-phase systems.

In a following step 140, a change of variables is applied, considering:

X_{d}=I_{q}³+I_{d}³

X_{d}=I_{q}−I_{d}

Lₛ=L_{q}=L_{d} (5)

This makes it possible to express the control system (1) in the form:

$$\{ \begin{matrix}{I}_{d}^{2} {V}_{d} + {I}_{q}^{2} {V}_{q} = {R}_{s} {X}_{d} + \frac{{L}_{s}}{3} {\dot{X}}_{d} - {ω}_{r} {I}_{q} [ {L}_{s} {I}_{d} ( {I}_{q} - {I}_{d} ) + {φ}_{f} ] \\ - {V}_{d} + {V}_{q} = {R}_{s} {X}_{q} + {L}_{q} {\dot{X}}_{q} + {ω}_{r} [ {L}_{s} ( {I}_{d} - {I}_{q} ) + {φ}_{f} ]\end{matrix} \qquad ( 6 )$$

In addition, given that I_{d}I_{q}(I_{q}−I_{d})≠I_{d}+I_{q}≠X_{d}≠X_{q}, it is possible to write considering U_{d}=I_{d}²V_{d}+I_{q}²V_{q} and U_{q}=−V_{d}+V_{q}:

$$\{ \begin{matrix}{U}_{d} = {R}_{s} {X}_{d} + \frac{{L}_{s}}{3} {\dot{X}}_{d} + {P}_{d} ( t ) \\ {U}_{q} = {R}_{s} {X}_{q} + {L}_{q} {\dot{X}}_{q} + {P}_{q} ( t )\end{matrix} \qquad ( 7 )$$

With U_{d} and U_{q} control parameters each comprising, respectively, endogenous variables dependent on the variables X_{q}, X_{d} or the derivative thereof making it possible to control the electromagnetic torque Cₑₘ, and an exogenous variable P_{q}(t) or P_{d}(t), which are disturbances.

Because the variables of disturbances P_{q}(t) or P_{d}(t) are exogenous, the system (7) makes it possible to provide frequency-based isolation of the disturbances in relation to the terms governing the electromagnetic torque.

Thus, it is possible to offset the disturbances and to regulate the electromagnetic torque by implementing, in a step 150, a regulation of the control parameters U_{d} and U_{q}. This regulation makes it possible to smooth the current ripples generated by the electric machine. In addition, the system of equation (7) shows that the regulation of the control parameters U_{d} and U_{q} is provided without dependence on the state of the rotor of the electric machine.

The values of the control parameters U_{d} and U_{q} are calculated on the basis of the system:

$$\{ \begin{matrix}{U}_{d} = {K}_{d} ( {X}_{d}^{req} - {X}_{d} ) + {K}_{id} \int ( {X}_{d}^{req} - {X}_{d} ) d t \\ {U}_{q} = {K}_{q} ( {X}_{q}^{req} - {X}_{q} ) + {K}_{iq} \int ( {X}_{q}^{req} - {X}_{q} ) d t\end{matrix} \qquad ( 8 )$$

With K_{d}, K_{id}, K_{q}, K_{iq} representing the predetermined constant gains, and X_{d}^{req}=(I_{q}^{req})³+(I_{d}^{req})³ and X_{q}^{req}=I_{q}^{req}−I_{d}^{req}.

In a step 160, the values of the components of voltage V_{d} and V_{q} applied across the two axes (direct axis and quadrature axis respectively) of the Park plan of the electric machine are determined on the basis of the control parameters U_{d} and U_{q} and the matrix system:

$$[ \begin{matrix}{V}_{d} \\ {V}_{q}\end{matrix} ] = {[ \begin{matrix}{I}_{d}^{2} & {I}_{q}^{2} \\ - 1 & 1\end{matrix} ]}^{- 1} [ \begin{matrix}{U}_{d} \\ {U}_{q}\end{matrix} ] \qquad ( 9 )$$

Then, in a step 170, an inverse Park's transform is applied on the basis of the direct and quadratic components of voltage V_{d} and V_{q} so as to obtain the control voltage values U₁, U₂, U₃ of the inverter coupled between the supply battery of the motor vehicle and the electric machine.

In a final step 180, the voltages U₁₂, U₂₃, U₃₁ generated by the inverter on the basis of the mono-phase voltage V_{bat} of the battery and the values of the control voltages U₁, U₂, U₃ are applied to the terminals of the electric machine.

FIG. 2 illustrates a system for controlling the electromagnetic torque of a permanent-magnet three-phase electric machine implementing the control method according to the invention in accordance with an embodiment of the invention.

The system 1 for controlling the electromagnetic torque of a permanent-magnet three-phase synchronous machine 10 comprises means 2 for measuring the current delivered across the three phases I₁, I₂, I₃ of the electric machine 10. These measurement means 2 are coupled to transposition means 3 making it possible to transpose the three currents measured into a direct component I_{d} and a quadratic component I_{q} of current on the basis of Park's transform. The control system 1 also comprises transformation means 4 able to convert the torque setpoint Cₑₘ^{req} into a setpoint I_{q}^{req} for the quadratic component I_{q} of current and into a setpoint I_{d}^{req} for the direct component I_{d} of current, and first variable change means 5 able to determine new current variables X_{q} and X_{d} and new current setpoints X_{d}^{req} and I_{q}^{req} on the basis of the direct and quadratic components of current I_{d} and I_{q} and the corresponding setpoints I_{q}_{_{—}}_{req} and I_{d}_{_{—}}_{req} and the equations:

X_{d}=I_{q}³+I_{d}³ and X_{q}=I_{q}−I_{d} and

X_{d}^{req}=(I_{q}^{req})³+(I_{d}^{req})³ and X_{q}^{req}=I_{q}^{req}−I_{d}^{req}.

The control system 1 comprises a regulator 6 able to determine control parameters U_{d} and U_{q} each comprising, respectively, endogenous variables dependent on the variables X_{q}, X_{d} or the derivative thereof and making it possible to control the electromagnetic torque Cₑₘ, and an exogenous variable P_{q}(t) or P_{d}(t), which represent disturbances caused by the flux generated by the magnets of the rotor, the control parameters U_{d} and U_{q} being expressed in accordance with system (7) and being calculated in accordance with system (8).

The control system 1 comprises means 7 for determining the components of voltage V_{d} and V_{q} applied across the two axes (direct axis and quadrature axis respectively) of the Park plan of the electric machine on the basis of the control parameters U_{d} and U_{q} and the matrix system (9).

The system comprises inverse transposition means 8 able to apply an inverse Park's transform on the basis of the direct and quadratic components of voltage V_{d} and V_{q} so as to obtain the values of the control voltages U₁, U₂, U₃ of the inverter 11 coupled between the supply battery 12 of the motor vehicle and the electric machine 10. The system lastly comprises control means 9 able to control the inverter 11 on the basis of the determined values of the control voltages U₁, U₂, U₃.

The invention thus makes it possible to control the electromagnetic torque of a permanent-magnet electric machine while ensuring the stability of the currents in the electric machine, whatever the state of the electric machine.

It should be noted that the invention can be easily transposed by a person skilled in the art to an unsymmetrical electric machine between the direct axis and the quadrature axis of the Park space and thus for which L_{d} is different from L_{q}, this transposition being performed by managing differently the setpoints of current along these two axes in order to provide the requested torques.

1-8. (canceled)

9. A system for controlling an electromagnetic torque of a permanent-magnet three-phase electric machine, comprising:
means for measuring current delivered across three phases of the machine;
transposition means configured to transpose the three currents measured into a direct component and a quadratic component of current based on a transform of three-phase systems;
transformation means configured to convert a torque setpoint into a setpoint for the quadratic component of current and a setpoint for the direct component of current,
means for determining control voltages; and
control means configured to apply the determined control voltages to the electric machine;
wherein the means for determining comprises a first calculation module receiving the direct and quadratic components of current and the setpoints, the first calculation module configured to apply a change of variables and to provide a set of control variables to a regulation module configured to deliver control parameters calculated based on a system of equations as a function of the control variables, the system of equations isolating disturbance terms caused by flux generated by magnets of a rotor of the electric machine from terms contributing to the electromagnetic torque, and a second calculation module configured to calculate the control voltages based on the direct and quadratic components of voltage determined based on the control parameters.

10. The system as claimed in claim 9, wherein the electric machine has a symmetry between a direct axis and a quadrature axis of a plan of the transform of three-phase systems, making it possible to obtain a direct component of equivalent inductance substantially equivalent to the quadratic component of equivalent inductance.

11. The system as claimed in claim 9, further comprising transposition means configured to apply a Park's transform to the currents measured to obtain the direct component and the quadratic component of current.

12. A motor vehicle comprising an electric machine comprising a control system as claimed in claim 9.

13. The motor vehicle as claimed in claim 12, further comprising a hybrid transmission also including a heat engine.

14. A method for controlling electromagnetic torque of a permanent-magnet three-phase electric machine, comprising:
measuring current delivered across three phases of the electric machine;
transposing the three currents measured into a direct component and a quadratic component of current based on a transform of three-phase systems;
receiving two setpoints for the quadratic component and the direct component of current in a plan associated with the transform of three-phase systems;
determining control voltages and control of the control voltages to be applied to the electric machine;
wherein the determining the control voltages comprises a change of variable providing control variables, a regulation of control parameters calculated based on a system of equations expressed as a function of the control variables, the system of equations isolating disturbance terms caused by flux generated by magnets of a rotor of the electric machine from terms contributing to the electromagnetic torque, and calculation of the control voltages based on the direct and quadratic components of voltage determined based on the control parameters.

15. The method as claimed in claim 14, wherein the electric machine has a symmetry between a direct axis and a quadrature axis of a plan of the transform of three-phase systems, making it possible to obtain a direct component of equivalent inductance substantially equivalent to the quadratic component of equivalent inductance.

16. The method as claimed in claim 14, wherein the transform of three-phase systems is a Park's transform.
